(19) United States
(12) Patent Application Publication
(10) Pub. No.: US 2016/0358214 A1
(43) Pub. Date: Dec. 8, 2016

(54) PASSIVE SOCIAL NETWORKING USING LOCATION

(71) Applicant: OPEN GARDEN INC, San Francisco, CA (US)

(72) Inventors: Stanislav Shalunov, Lafayette, CA (US); Gregory Hazel, San Francisco, CA (US); Micha Benoliel, San Francisco, CA (US)

(21) Appl. No.: 14/758,960

(22) PCT Filed: Feb. 20, 2015
(86) PCT No.: PCT/US2015/016965

§ 371 Date: Jul. 2, 2015

Related U.S. Application Data
(60) Provisional application No. 61/943,281, filed on Feb. 21, 2014.

(51) Int. Cl. G06Q 30/02; H04W 4/02

(52) U.S. Cl. CPC G06Q 30/0261; H04W 4/023; G06Q 30/0267; G06Q 50/01

(57) ABSTRACT

A system and a method for collecting passively generated time-stamped location data from mobile devices and using this data to generate social network. The social network utilizes the data to determine a user's friends, family members, coworkers, and other associates. The system and a method improve social networking applications by automatically generating friend lists and user lists, and for automatically keeping these lists up to date. Further, the data can be used for social discovery, including dating, professional networking, and travel applications. The system and method further uses this data to determine a user's hobbies and interests. A recommendation engine may be used to generate recommendations for products, services, and businesses based on passive location data. A system and a method for an advertising system for products, services, and businesses based on passive location data are also disclosed.

### RELATED APPLICATIONS

This Application claims priority benefit from U.S. Provisional Application Ser. No. 61/943,281, filed on Feb. 21, 2014, the disclosure of which is incorporated herein in its entirety.

### BACKGROUND

### 1. Field

This disclosure relates to the intersection of social networks and smart mobile devices.

### 2. Related Arts

The traditional social networks, such as Facebook, engage users directly, asking them explicitly about their interests, what they “like”, who their friends are, to whom they're married or with whom they're in a relationship, and so on. This approach has two major flaws: it's time-consuming and inaccurate. To work properly, users must spend a lot of time inputting this data. The data is likely incomplete or inaccurate even from the moment a user enters it, and any of the data that is accurate likely becomes obsolete quickly. Users must explicitly specify their interests and locate, send, and confirm friendship requests. Few users accurately update their lists as their interests and friendships evolve over time, so this information can quickly become out of date.

Mobile device users generate location data. By the simple act of carrying a mobile or wearable device, users reveal their whereabouts continuously, within the accuracy of the aid of GPS, assisted GPS, Wi-Fi signals and their strengths, cellular towers, and their signal strengths, differential GPS. The error estimate is based chiefly on the method with which location is obtained. For example, cell tower signal strengths give coarse location estimates; location estimates using satellite technologies such as GPS and GLONASS are the most precise. Current generation mobile devices have sufficiently accurate GPS technology to pinpoint a location to within a few meters.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Disclosed embodiments utilize inherent capabilities of smart mobile devices to improve the functionality, usability and accuracy of social networks.

Various disclosed embodiments provide new possibilities in the areas of
1. Social networking
2. Social discovery
3. Recommendations
4. Advertising

Since devices generate a time-stamped location upon request, it is possible to determine not only the location of each user, but also how long a user is in a particular location. This data is generated passively by the mobile device, i.e. without requiring any user action. Hence it is possible to obtain quadruples of the form <user, time, location, error estimate>. Disclosed embodiments provide novel services to mobile device users using this data, and opportunities for social networks and advertisers to monetize this data. By capturing, storing, and processing the passively generated quadruples described above, it is possible to determine:
which users spend time together
how much time they spend together
where they spend it
the location of a user's home and workplace
other locations a user frequents

Using this data, disclosed embodiments can automatically generate appropriately categorized friend lists and interest lists for each user, which are refer to herein collectively as the social graph.

Various disclosed embodiments provide systems and methods for collecting passively generated time-stamped location data from mobile device users and using this data to determine a user's friends, family members, coworkers, and other associates.

Further disclosed embodiments provide systems and methods for collecting passively generated time-stamped location data from mobile device users and using this data to determine a user's hobbies and interests.

The disclosed embodiments can be implemented for improved social networking applications by automatically generating friend lists and user lists, and for automatically keeping these lists up to date. Also, the embodiments can be implemented as system and a method for social discovery, including dating, professional networking, and travel applications as described above. Additionally, a system and a method can be implemented for a recommendation engine to generate recommendations for products, services, and businesses based on passive location data, and for an advertising system for products, services, and businesses based on passive location data.

### BRIEF DESCRIPTION OF THE DRAWINGS

Other aspects and features of the invention would be apparent from the detailed description, which is made with reference to the following drawings. It should be mentioned that the detailed description and the drawings provide various non-limiting examples of various embodiments of the invention, which is defined by the appended claims.

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

The Figures illustrate various graphs/relationships computed by the system in a graphical manner. However, there is no need to actually construct the graphs as presented herein, but rather accumulating the relevant data for constructing the graphs is sufficient. The graphs presented herein are for the purpose of understanding of the various data and relationships gathered and computed by the system.

FIG. 1 illustrates examples of quadruples used to compute social graph, according to one embodiment;

FIG. 2 illustrates an example of enhanced social graph with edges, according to one embodiment. The diagram indicates how connections between users may be thought of as n-tuples of weights, or mappings from a set of categories to numeric weights, where each coordinate of the n-tuple represents a category which connects two users;

FIG. 3 illustrates a fragment of a social graph, relating to only two users, according to one embodiment;

FIG. 4 illustrates the social graph superimposed over a section of a map in a particular moment in time, according to one embodiment. The diagram illustrates the social graph restricted to users (broadly construed to include devices and persons) and the connections among them. In this diagram, the connections among users are indicated with thicker arrows indicating stronger connections. Note also how the varying shapes indicating users (circle, oval, etc.) reflect how the reception of that user device may vary depending on antenna configurations, cell tower signal strengths, and battery power;

FIG. 5 illustrates the social graph superimposed over a section of a map in a particular moment in time, with the addition of indicating users interests;

FIG. 6 illustrates an embodiment for business and products mapping. The diagram indicates associations between businesses and products, wherein circles on the map indicate businesses and circles in the legend indicate products, while arrows indicate that a business sells (associated with) a product;

FIG. 7 illustrates an example of product and interests mapping;

FIG. 8 illustrates an embodiment that overlays the product-business associations with the product-interest associations;

FIG. 9 illustrates an embodiment that overlays the business-product mapping with the social diagram mapping, with just the user connections;

FIG. 10 illustrates and embodiment that overlays the business-product map with the full social graph diagram, i.e. the social connections and the user interest information.

FIG. 11 illustrates an embodiment that adds to the mapping of FIG. 10 the association of user interests with products.

FIG. 12 illustrates a flow chart of a method according to one embodiment of the invention.

FIG. 13 is a schematic illustration of an embodiment wherein the system is implemented using mobile-device installed clients only, without a server.

### DETAILED DESCRIPTION

From the description provided herein, it should be appreciated that embodiments of the invention solve two problems at once: the system no longer needs explicit user action, as existing social networks such Facebook and Linkedin do, and the system automatically gathers more accurate and updated data. The system use physical location and time spent together to construct, classify, and rank friendships and relationships lists. This represents a novel improvement over existing social networking systems because physical time is a better proxy for closeness of friendships than virtual time. Consequently, as will be further demonstrated below, embodiments of the invention include the advantages of:
a. Passive social networking using location generates friendship and interest data without explicit user input.
b. Passive social networking using location generates higher quality friendship data than existing social networks.
c. Enabling targeted commerce by crossing social network and location information.

Various embodiments will be described below with reference to various features. These features need not be implemented fully in each case, but rather may be mixed-and-matched as deemed fit for a particular situation.

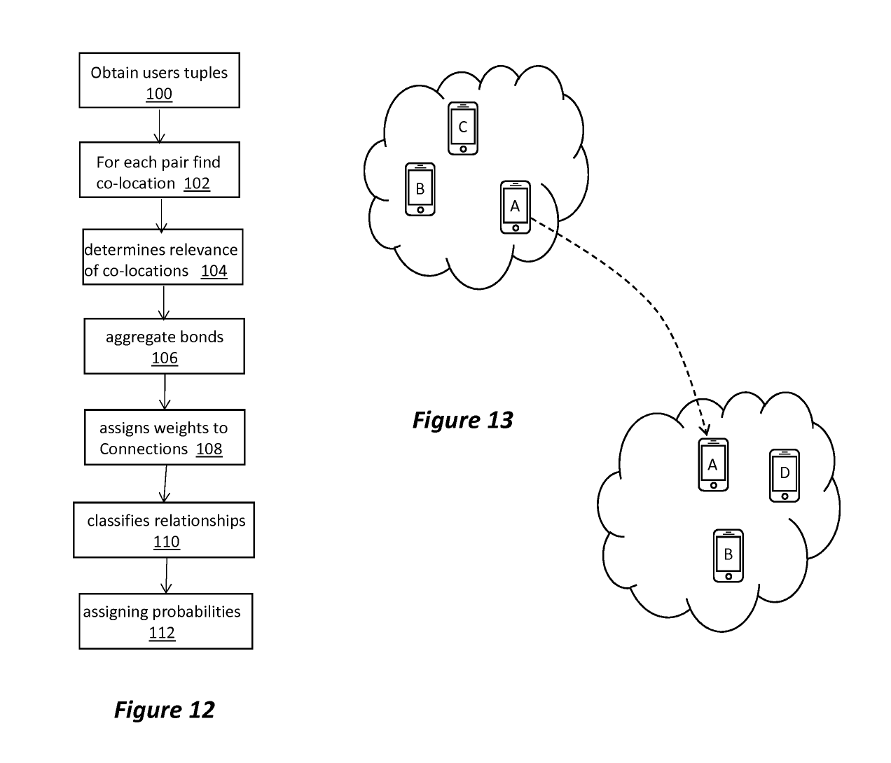

Disclosed herein is a co-location recommendation system, that considers all pairs of users. A general flow chart of the process is illustrated in FIG. 12. The system continuously collects tuples from users' mobile devices (100). The tuples may include device/user, time, location, and optionally location error. For each pair, the system finds all the locations where these users are at the same time, or at different times (102). A function determines the relevance of these co-locations based on whether they are concurrent or non-concurrent, the durations, the nature of the particular location, and other factors to determine the strength of the connection (104). For each pair of users, we take the take the aggregate of these bonds to other users across all locations (106), using a second function that assigns weights to these different connections (108). A third function classifies the relationships, for example, determining if two users are possibly coworkers, roommates, family members, and so on (110). Our friendship classifier separates relationships into discrete categories such as coworker, family member, and so on, and infers closeness based on the context of relationship type. This is done internally by assigning probabilities to different types of relationships and using thresholds to turn them into discrete specific relationships (e.g., we may believe that it is 90% likely that X and Y and family members and present this simply as “X and Y are family members”) (112).

To better understand the classification of relationship, consider the following example. Suppose that two people spend almost all their nights at the same house, but don't spend the days together. We may infer that these people are family members, roommates, or neighbors. If, in addition, these people frequently go out together, that would indicate they are family members or roommates, rather than neighbors. If they travel together, it's likely that they're family members. Alternatively, we can infer that people are coworkers if they spend weekdays together in an office building, but not weekends.

Basic friend lists: By implementing this feature, not only do users not have to initially build a friend list, users do not need to do anything to update it. A system which implements this feature would maintain the list's accuracy using location data, including the relationship strengths and classifications, by continuously monitoring user activity. If one user no longer spends time with another, each user's friend list is appropriately and automatically updated. If a user changes employers and no longer frequents the same work site, lunch spots, or commuting routes, all this information is updated automatically, based on the location-based data the user generates just by changing his daily routine.

Context-based friend lists: By implementing this feature, embodiments of the invention automatically maintain and track lists based on context, even over multiple social network applications. That is, passive social networking using location obviates the need to maintain multiple friend lists. In practical terms, it would no longer be necessary to switch between, say, Facebook and Linkedin friend lists. Features of this embodiment subsume each of the used social networking lists by automatically detecting the context of a connection. For example, if one attends a conference, this feature makes it possible to obtain the list of conference attendees, and recognize them as a distinct relationship category.

Interest lists: By analyzing the quadruples described above, this feature automatically determines a user's interests. Embodiments disclosed perform this by examining where a user spends time. For example, if a user visits the ski slopes every weekend, the system knows that he is a committed skier. Or if a user attends the symphony regularly, the system knows that the user loves classical music. If he is on a lake every morning, we know he's passionate about water sports. If a user attends classic car shows, we know he's interested in classic cars. If she attends author book readings at local bookshops, we know she's a book lover. If he shops at farmer's markets and patronizes fine restaurants, we know he's passionate about food. In this way, the system develops a list of a user's genuine set of interests, as well as the level of commitment to each, that is more accurate than the interest list the user might specify on Facebook, or any other social network based on explicit user input. A user-provided interest list may be flawed for any number of reasons, including these:
The user may never have filled in the “interests” section.
The user may have incompletely filled in the “interests” section.
Some of the “interests” a user listed may be more aspirations than actual.
The user may fail to update the list as to reflect new interests or drop old ones.

The feature of Interest Lists may be implemented using various methods. According to one example, the quadruples data is used to create what we refer to as the enhanced social graph, which may be defined as a graph consisting of nodes which represent users and their interests, and weighted edges that represent direct connections between users, where higher valued weights indicate stronger connections. Each edge weight is an n-tuple, where each coordinate in the tuple describes a weight in a distinct “dimension”. One such dimension might represent a familial connection, another might represent a social connection, a third might be professional connection, a fourth might represent a connection based on some hobby or other interest, and so on. Equivalently, each edge may be thought of as defining a mapping from a set of categories of relationships (family, friends, coworkers, classmates, bridge partners, soccer teammates, etc.) to numeric weights that represent the strengths of those relationships. These categories do not need to be predefined; they evolve along with the user's connections and interests. This social graph offers ways to improve services for dating, finding friends, finding friend-of-friends, professional associates, and people with similar interests. Socially close people are potentially more interesting than random population. This social graph may be used in any of the following application domains.

### 1. Social Networking

As noted in the Background section, traditional social networks engage users directly, asking them explicitly about their interests, what they “like”, who their friends are, to whom they're married or with whom they're in a relationship, and so on. This approach has two major flaws: it's time-consuming and inaccurate. To work properly, users must spend a lot of time inputting this data. The data is likely incomplete or inaccurate even from the moment a user enters it, and any of the data that is accurate likely becomes obsolete quickly. Users must explicitly specify their interests and locate, send, and confirm friendship requests. Few users accurately update their lists as their interests and friendships evolve over time, so this information can quickly become out of date.

By contrast, the disclosed embodiments require no explicit user action, but rather infer who a user's friends are, what their hobbies and interests are, by examining the location data by any of the methods described herein. This permits numerous improvements over the traditional explicit approach. Not only do users not have to take the time to initiate and maintain friendship lists explicitly, they do not have to even categorize associates into various pre-defined categories or “circles.” If two people are at the same address most nights, for example, we infer they live in the same home, whether as roommates or family members. If two people are together during weekday business hours, we infer they are coworkers. If two people are at the same bowling alley, climbing gym, or pub at the same time on a regular basis, we infer not only that they are friends, but more specifically, that they are climbing buddies, bowling teammates, or drinking buddies, respectively.

More generally, we use the time of day, time duration, and location that users spend together to classify their relationships within a broad array of contexts. We also use the quantity of communication between a pair of users: the more frequently they message each other, or the longer and more often they speak to each other, the stronger the connection of family or friendship. In this way, we determine who the important people are in each user's life.

Providing useful information: According to this feature, the system provides users with useful information as a natural consequence of collecting the passive location data. For example, we identify to a specific user other users whose commutes originate and terminate in nearby locations, enabling hitherto unknown ride-sharing options, without using ride-sharing websites. More generally, this feature provides a user with a service that enables a user to identify other users with any other common interest or a priori knowledge of these users. We can supply information in a user's newsfeed that provides updates about former coworkers, members of common interest clubs, in conjunction with their activities related to those interests. Hence, we offer additional user benefits and open the door to novel uses unlike those offered by existing social networks. Useful information can be provided even from people who are not connected by social graph but tend to visit common locations. For example, if it is determined that both users A and B tend to visit establishment X frequently, but it also noted that user A sometimes visit establishment Y but user B does not, it can be inferred that perhaps user B doesn't know about establishment Y and may be interested in learning about it. For this association it is not necessary that users A and B have social connection.

### 2. Social Discovery

Using the methods described in the section above, disclosed embodiments enable users to identify and connect with other users in diverse contexts.
a. Dating systems: Dating sites have trouble accessing the social graph, which would help them identify and introduce well-matched users. This difficulty stems from privacy concerns which lead users to sign up with pseudonyms. Using passively provided location data, we can provide dating services with more powerful features than existing dating systems have based on the traditional explicit data gathering model. Passively collecting location data provides access to the social graph, so it identifies users of interest to other users. For example, if two people both go to the symphony (but on different nights), or both go to a gym (but at different times), we can recognize these common interests and suggest introductions. Using the social graph, we are able to determine better quality matches than those pseudonymously based dating system can provide, and identify users who are both signed up for the same dating service who are near each other in the social graph. We can use the basic friend list obtained from traditional social networking in conjunction with the social graph to determine appropriate potential introductions. For example, we can determine who a user's coworkers are and exclude them as potential bridges for dating connections. Similarly, we can recognize that someone who shares a user's passion for French poetry and is close in the social graph would make an appropriate connection. This is possible because we have information about a user's true interests—not just what they say in their profiles. We can even make recommendations based on interests that the user has not explicitly specified. For example, when filling out her profile, a user might consider it too mundane or clichéd to mention, for example, that she likes walking on beaches, or walking around city streets. If we observe two users with similar such actual behavior, we can note the common interest and suggest a connection.
b. Professional networking: We identify those individuals a user may want to meet based on his or her behavior. For example, they may be attending similar conferences, even though their professions are different: one may work in engineering while another may work in business development, but they may each have a strong interest, say, in biotechnology or solar power. Based on explicitly provided information, an existing social network might not suggest these same connections (since interests lists in Facebook, for example, may represent aspirations rather than current reality). By contrast, the passive social network system uses actual behavior information to provide a fuller set of appropriate matching. Here too, we use the social graph to determine users who have overlapping professional interests, and who would find value in a system that identifies other such individuals. The capabilities of this invention transcend the obvious similarities to existing social networks based on professional associates such as Linkedin. Because we use actual observed behavior, we can draw inferences that may appear too obvious or mundane for a user to even mention. For example, a user may indicate an interest in “developing online shopping carts” but omit to mention “e-commerce” or “software development.” Similarly, a user may specify she is an oncologist, but omit the general category of “medical doctor.” In general, a user may specify a narrow professional interest while omitting to mention the generic larger containing category. Through actual user behavior, we can determine such containing categories. By accessing location data, we augment explicitly supplied interests with inferred interests based on attendance on same types of events (for example: meetups, conferences, colloquia, lectures, seminars), especially if attendance is frequent and regular. Actual user behavior trumps explicitly supplied interests because user provided interests are hard to weight and become obsolete. Our system uses a constantly updated and refreshed location stream to provide current information about which interests are current and strongest. It also makes judgments about which kinds of associates are most appropriate for which applications. For example, social and family members are likely to be appropriate for social introductions; coworkers, professional colleagues, and dissertation advisors, are more appropriate for professional introductions. Since our system has the context of the relationship, we can recommend appropriate people to a user who is interested in receiving particular kinds of introductions.
c. Visitors to a new city: We enable a user visiting a new city to locate people who are close in some way. For example, they might have friends, interests, or work histories in common. Again, we use the information embedded in the social graph to make visible to a user those users in other locations who share connections on one or more levels. Our techniques enable us to recommend a wide set of introductions: starting with a user's list of friends, and augmenting the friend list by expand outward along the social graph (considering those users successively more hops away), while simultaneously narrowing that set by focusing on those users with the strongest connections and who share most strongly the user's professional interests, hobbies, favorite travel destinations, or whatever other interests with which the user is currently engaged.

The above discussion identifies two broad categories of applications: those which identify actual connections, and those which discover new potential connections or applications. Social networking online may therefore be viewed as bimodal, with social discovery applications on one end of a spectrum (e.g. dating), and applications that manage actual (current) connections on the other end. Passive social networking using location handles both equally well since it knows the user's actual behavior. The list of examples above (dating, professional networking, visiting a new city), is not exhaustive. There are potentially many other applications, for example, finding activity partners who share any given interest or activity, be it attending symphony concerts, bicycling, running, playing chess, or discussing literature or politics. The power of our techniques lies in the accuracy of our interest lists, which derives from knowing a user's actual behavior, wherein the user's behavior is generated by collecting the time-location tuples from the user's mobile device.

More examples arise from considering the transitive closure of co-location-based friendships and associations. Suppose users A and B frequently go to the same places, we may infer a relationship between them. Suppose also that users B and C go to common places (which may be different from the places common to A and B). From this, we may infer that A and C are connected via user B, and consequently might know one another. We can then form a tie between A and C, even if it is possibly weaker than the A-B or B-C ties, and use that tie to recommend products and target ads.

### 3. Recommendation Engine

Just as the social graph can identify like-minded individuals to each other, it can identify and recommend a wide array of products and services to users, for example: books, movies, music, restaurants, night life, dancing, sports activities, travel destinations, etc. Here again, this is very broadly applicable: it not possible to make an exhaustive list. Moreover, we can use the social graph to make these recommendations based on, for example:
a. what a user's friends like: All three of techniques listed above can be brought to bear here: we can use the user's list of interests and his friends lists (both the basic list of friends and the context-based friend lists) to recommend products, services, and businesses that we know he'll have an interest in and that his friends like (since we know who his friends are, and we know their interests as well as his), particularly those friends on context-based friend lists where the context is relevant to the product, service, or business being recommended.
b. what friends of a user's friends like: If looking at a user's friends is insufficient (perhaps none share the interest in the recommendations we're targeting), we can augment the connections we use by including friends of friends. While the connections are more tenuous, there are many more of them. Otherwise, the same reasoning in a. applies in this context as well. Note that a. and b. are extensions of a user-based recommendation methodology.
c. cross-product recommendations: We can recommend a product, service, or business in category Y to a user if she and her friends (or possibly friends of her friends, etc.) have a common taste for a product, service, or business in category X. For example, we might recommend a restaurant to a user if a friend of hers likes that restaurant, and we know that she and that friend happen to have similar tastes in music or books. Note that our power to make such cross-recommendations arises from our knowledge of who a user's friends are, who the friends of her friends are, and so on, as well as our knowledge of her interests. Note that this is an extension of item-based recommendation.
d. Location-based recommendation: We can also recommend products, establishments, events, etc., based on users who frequent similar locations, regardless of whether the users are connected via a social graph. If it is determined that certain users tend to visit certain locations that have context connection, for example, all of these locations are swimming pools, thereby are connected by the context swimming, health or sport, then certain actions of one user from the group may be relevant or interesting to other members, even if none of the users know each other or are connected socially. Thus, if one of the group frequent a certain swimsuit shop and it is determined that the others do not, we may infer that the others are not aware of this shop and provide information about the shop for them, without the need to identify the user who did frequent that shop. This should be distinguished from the traditional location-based recommendation, wherein for example, if a user is determined to be near a coffee shop, an ad or coupon of the coffee shop is sent to the user's device. By contrast, this method associates users with not just places, but with other users (whether they are connected socially or not). First, we create user-to-user associations based on similarities of interests, activities, etc., among people. Then, we use this user-to-user association to make recommendations. If a set of users frequent the same location, and we know the interests of some of the people in this set, recommending those interests to other members of this set is beneficial. For example, if a user frequently co-locates at the same places as people who frequently travel to Hawaii, our recommendation engine may infer that even if that user doesn't have a history of Hawaiian travel, but she may be the kind of person who might. Therefore, serving Hawaii-related travel ads would be relevant. As another example, instead of Hawaii-specific recommendations, we may recommend ads related to a specific activity such as snorkeling that is available in Hawaii, as well as other places.

These are just examples; our techniques offer a multitude of possibilities. Our system is different from existing recommendation engines because we use passive location to discover users' friends and interests.

We can use this system to show users various relevant content, for example, the news articles that their coworkers are reading, which is likely to be professionally relevant. Different apps may use different types of associations: LinkedIn could show a user what his co-workers are reading; Facebook may show a user what her family and friends are reading (or shopping for), with or without a direct association of the actions of who read them. We could also identify who read them, which might increase the relevance or interest. For example, if someone a user respects is a reader of an article, that user is more likely to read it too.

In general, it has been found that people prefer having an explanation for a recommendation. Hence, the quality a recommendation may not be as important as its explanation. The disclosed system can generate this explanation, where the recommendation itself it not necessarily generated by the system. For example, if a user receives an ad for Starbucks, then the system can show the user which of her friends go to Starbucks (if she has specified them, for example, to Facebook), but it can also do so by inferring who her friends are by location. This allows an ad network that does not have any explicit social graph data display social context for ads.

### 4. Advertising

Social networking attracts investors by their ability to sell ads. Ads can be made more valuable by smarter targeting, since the social network knows so much about the user. We enable better targeting. By knowing a user's real interests and real friends based on actual location data, we create a more accurate “social graph” and “interest graph”, and hence permit superior targeting. By using the enhanced social graph in an advertising context, we create additional value. There are a wide variety of such contexts: we might be an advertiser or an entire ad network, or sell services to advertisers or ad networks, or any of a wide set of actors who can exploit this information, for example: publishers, research organizations, third party providers of information to any of the above. We can potentially even provision software running on the user's device that makes ads more relevant by using this information whenever ads are displayed.

Today's social networks like Facebook need users' social graphs and lists of interests, as explicitly constructed by users, to give socially relevant ads. However, “Facebook” friends are not a true measure of actual friendship, and user-stated interests may not accurately reflect the actual level of commitment. For example, two people may indicate they “like” skiing, but one may go every week, while the other may go once a year. Facebook interest lists may be inaccurate for a host of reasons, including those listed above in the paragraph labeled “interest lists.” Since we generate interest lists based on actual observed behavior, to which a user devotes actual physical time, our interest lists are superior to interest lists generated by traditional social networks. Therefore, we are able to target ads more accurately than traditional social networks. This improvement in the quality of ad targeting adds value to any advertiser or advertising network. We can also target ads based on a variety of criteria, not just by interests, but also by social graph, by work place, by frequenting a location, by being at a location at a specific time, by home location, by frequent travel destinations, by workplace, and so on. As an example of “social graph targeting,” we could show friends who like skiing next to an ad for a ski resort, or show other people who actually go to it, or show someone with a close connection to a user and a slight connection to a ski area, rather than strong skiers who you're not connected with as closely. Many diverse strategies become possible using our techniques.

Taxonomical analysis: We employ another technique to broaden the applicability of interest lists to ad targeting. If we identify a user is interested in, for example, rowing, or kayaking, or sailing, or waterskiing, we know more broadly he is interested in water sports and boating. If we know a user is passionate about football, we know she is a sports fan. If a user attends farmer's markets, we know she is interested in food more generally. In each of these instances, we can generalize from specific to broader categories, thereby expanding the possibilities of ad targeting.

By focusing more on what users actually do, rather than on what they say, we can determine a more accurate picture of a user's genuine interests. Far more useful information upon which to base ad placement decisions can be obtained from friendship information inferred from physical time and location data than on explicitly created interest lists, which may be incomplete, out of date, or merely aspirational. Our passive system learns the social graph from user behavior, not user-generated input. Consequently, it knows users' actual friends and interests. This knowledge gives a competitive advantage in determining what kind of products users are likely to buy. By sheer knowledge of location, it becomes possible to provide a service like 4Square's without requiring users to even check in. It becomes possible to provide real-time location-based targeted ads. For example, when a user is known to attend one gym, it is possible to sell targeted ads to command a premium for showing ads to that user for competing gyms. These examples, along with others mentioned above, illustrate the ways in which ads can be targeted more accurately with our techniques than with traditional ones employed by established social networks. In this way, we add value to advertisers or ad networking firms.

This approach may be integrated into an existing tradition social network system. For example, disclosed embodiments could easily be integrated by a social network such as Facebook. The passive and active approaches can exist in tandem in such a way that the passive can augment the active. For example, the passive system could suggest potential friendships, i.e. indicate other users to whom a given user might like to send a friend request. Our system also permits a multi-pronged approach to ad targeting. We can target ads based on the social graph, interests, and current or visited locations.
Advertising by social graph: In this model, we advertise to a user products and services which her friends like.
Advertising by interests: In this model, we advertise to a user based on his actual observed interests.
Advertising by current location: In this model, we present ads for businesses close to a user's present location, or possibly for their competitors. For example, if a user is about to attend a gym, we might present a coupon for a competing gym that may be convenient, based on his work and home locations. As a user walks past a café, restaurant, or clothing boutique, we might note to the user that a friend of hers happens to like those establishments.
Advertising based on commonly visited location: In this model, we present ads based on behavior of users who are linked by having frequenting the same location or locations having the same or similar context—regardless of whether these users are connected socially. For example, suppose a group of users all frequent the same or different golf courses. That is, the frequented location(s) are of the same context, i.e., golf. When the system determines that one of the users has bought a certain brand/model of golf clubs or at a certain golf store, the system may makes a recommendation of the brand/model of golf clubs or golf store to the others in that group. Note that it is irrelevant whether the users in the group know each other or are connected socially. Similarly, when considering a single user, if the system finds that the user frequently has high proximity to people who the system knows play golf since they frequent gold courses, the system may identify the user as a person who exhibits a tendency, has a potential interest, or has an affinity, toward playing golf. In which case, the system may recommend golf clubs, golf shops, golf courses, etc. If the user indeed plays golf, the recommendations are directly relevant. Even if the user doesn't play golf, it may still be perceived as relevant, since the user engages routinely with users who play golf
Advertising based on commonality of contexts. In this model, we present ads based on behavior of users who are linked by sufficient common contexts, but also other contexts that are not common. Considering the above golf example, if Alice and Bob, who are frequent golfers, and Carol, who isn't, all frequent the same restaurant, go to the same dentist, live nearby, and commute to the same area in the city, we may recommend golf clubs to Carol, on the reasoning that Carol is similar to golfer Alice and Bob in enough ways that she may be interested in golf herself, and our system simply does not yet know this explicitly. That is, for a group of users who are linked by sufficiently common interests/contexts, the system identifies a specific context common to the group, but not associated with a specific user. The system then offers that specific context to the specific user.

Embodiments of the invention will now be described in more details, with reference to the drawings. In a first example, the method is implemented as an app that is downloaded and is installed on a mobile device, e.g., a smartphone, an iPad, etc. The app gains access to a mapping app, e.g., Googlemaps, OpenStreetMap, etc., to determine current location of the mobile device. The app may also have access to a timing program, which is conventionally integrated into mobile devices. By collecting location and time information, the app can, at any given time, generate a quadruple in the form of, e.g., <device, time, location, error estimate>, (error estimate relating to location). The app gains access and collects this data automatically and without user intervention.

As noted above, the aim of the app is to form social network of people; however, at its basic level the app knows only the device upon which it resides. As the app “learns” the usage of the device, it may be able to replace the device with a user name. Also, as the app reports activity on the mobile device to the server of the service provider, usage information is gathered and from that information the user accounts associated with services (e.g. Google, Facebook, and other mobile apps) can be coupled with mobile devices (noting that a user may use several mobile devices). The next level is for the app or system to associate people with accounts (usernames) and with devices. Thus, while the initial quadruple may be in the format <device, time, location, error estimate>, the system can progress to generate the quadruple in the format <username, time, location, error estimate>, and finally to the format <user, time, location, error estimate>. Since the method can operate using any of the formats, usage herein of one format should be taken to be interchangeable with a different format. Similarly, the use herein of the term “user(s)” may be broadly construed to interchangeably indicate a mobile hardware device, a user account for a mobile web service, or a specific person, and the use herein of the term “name” may interchangeably refer to a person's name or an account user name.

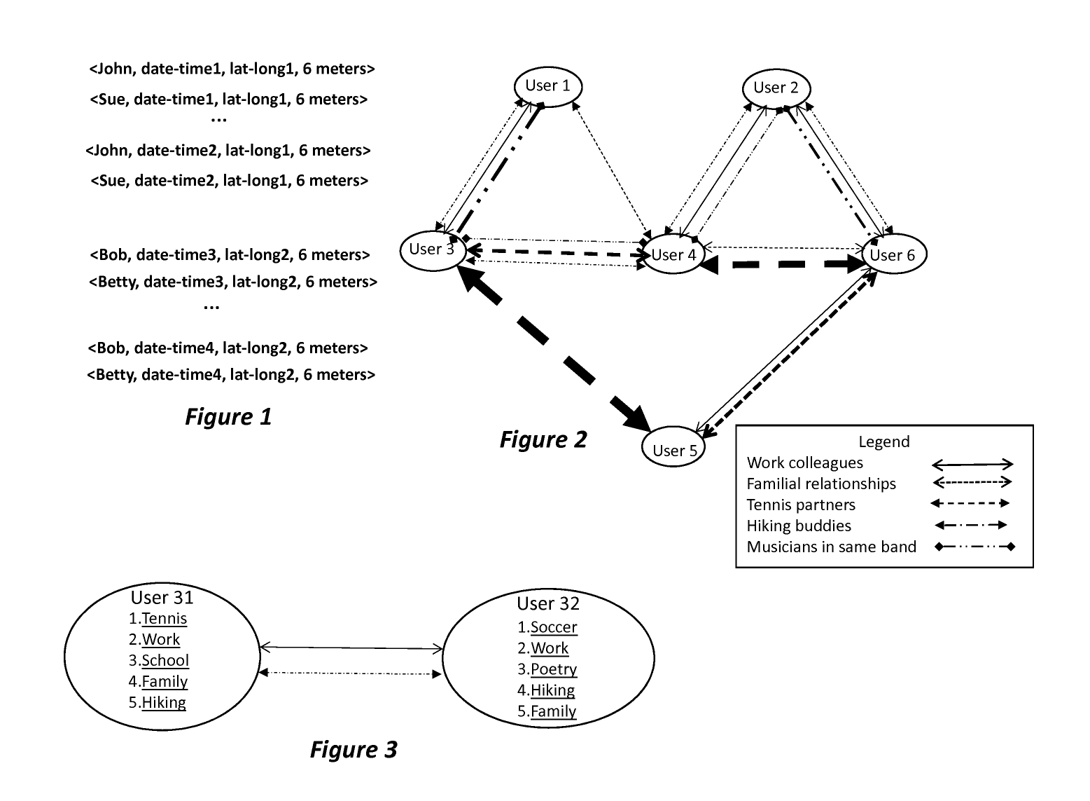

FIG. 1 illustrates examples of quadruples used to compute social graph, according to one embodiment. In this example the raw data of quadruples place John and Sue at the same place at the same time for a significant duration. By determining that lat-long1 represents the physical location of a book store, and that from date-time1 until date-time2 there was an author reading by the writer Amy Tan, we infer that John and Sue are both fans of Amy Tan, and more broadly, of literary memoirs. Also, the raw data place Bob and Betty at the same place at the same time for a significant duration. By determining that lat-long2 represents the physical location of a climbing gym, and that from date-time3 until date-time4 there was a climbing class, we infer that Bob and Betty are both fans of climbing, and more generally, of hiking and other outdoor sports.

The quadruples can be used to construct social graphs. An example of enhanced social graph with edges according to one embodiment is illustrated in FIG. 2. Of course, the graphs are for use by the application to generate the networks and need not be shown to the user. Each edge defines a mapping from a set of categories of relationships (family, friends, coworkers, classmates, bridge partners, soccer teammates, etc., as exemplified in the legend) to numeric weights that represent the strengths of those relationships. In the example of FIG. 2, weights are represented graphically by varying the arrow's thicknesses. Line types represent different relationship categories.

To illustrate, a relatively thick dashed-line arrow connects user 3 and user 5, indicating that they are closed tennis partners. This result could have come about by noting that they are often at the same place, arriving and leaving at the same proximate time, wherein the place has been determined (using Google, OpenStreetMap, Waze, etc.) to be a tennis court. As another example, user 1 and user 3 are connected by a thin solid arrow, indicating that they are work colleagues. This could be arrived at by noting that they are daily at the same location during work hours, where the location is determined to be a business. The arrow is thin, providing graphical indication of low weight, since they may not have any other interaction. The line may be thickened, providing a graphical indication for increased weight when it is determined that they are often at the same restaurant during lunch, when they appear to travel together, either commuting or business trip, etc.

FIG. 3 illustrates a fragment of a social graph, relating to only two users, according to one embodiment. This example of a fragment from the social graph illustrates two users who happen to be coworkers (the same legend of FIG. 2 is used in FIG. 3). Each node represents a user and encompasses a list of connection types based on the user's interests (including work and family). In the example above, the two users are coworkers, so the n-tuple representing the link consists of two components, one representing their coworker relationship, another representing the fact that they are hiking buddies as well.

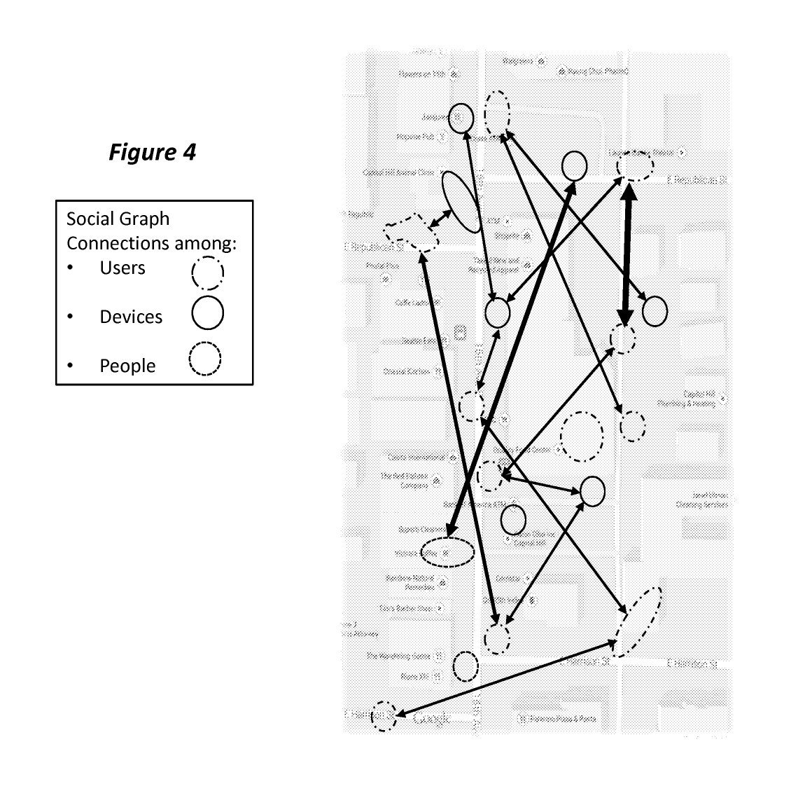

FIG. 4 illustrates the social graph superimposed over a section of a map in a particular moment in time, according to one embodiment. There are several features to note in this example. As explained above, on the most basic level, the system detects devices, since devices are what generate the quadruples: <device, time, location, error estimate>. As shown in FIG. 4, devices are indicated by a solid-line curve (circle, oval, etc.). As the system gathers usage information, it can associate user accounts for mobile services (e.g. Google, Facebook, and other mobile apps) with devices (dash-dot curve), and further, it can associate people with accounts and devices (dashed curve).

The curve, whether circle, oval, or other shape, indicates the possible location of the user. Varying error estimates may cause the region to which the system can place a device to vary in shape and size. The aim is to minimize the error such that the curve would cover, say, only one identified building. This enables concluding with certainty that the user is inside this building.

As in the prior embodiments, line thickness represents strength of friendship (or other commonality) connection.

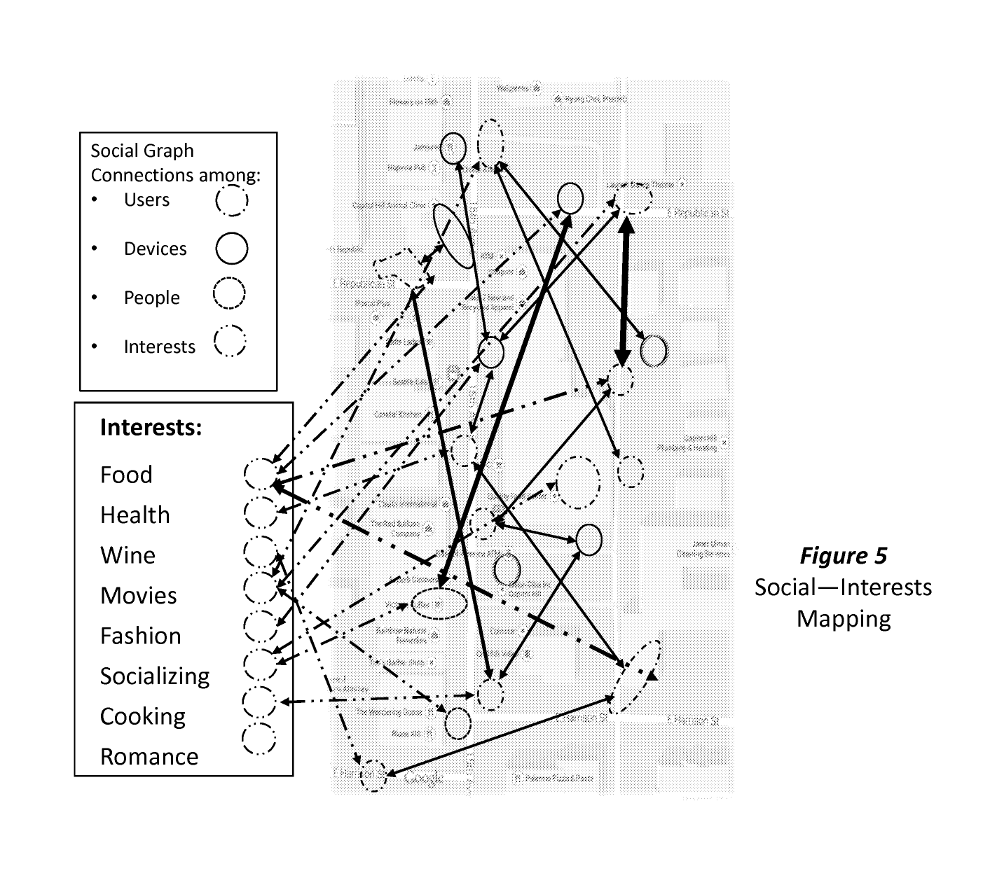

FIG. 5 illustrates the social graph superimposed over a section of a map in a particular moment in time, similar to the embodiment of FIG. 4, but with the addition of indicating users (understood to include devices and people) and their interests. This illustrates how each user is a mapping to a set of interests. Similar to the strength among connections, the thickness of the arrows represents interest strength. Interest strength can be deduced from the time the person (device) spends at places related to the interest. For example, if the user frequents a football stadium, the interest strength will increase and the arrow thickness will widen. Each of the geographical locations the user frequent can be identified as a specifically named place, such as a business establishment, a governmental building, an education facility, a public park, etc. This assists in concrete association of interests and geographical locations. For example, if a specific geographical location is identified as “Bill's Fish & Tackle”, it can be easily associated with interest named “fishing,” and more broadly category of “outdoors.” Similarly, if a geographical location is identified as “AT&T Stadium”, it can be easily associated with interest named “Baseball,” and more broadly “sport.”

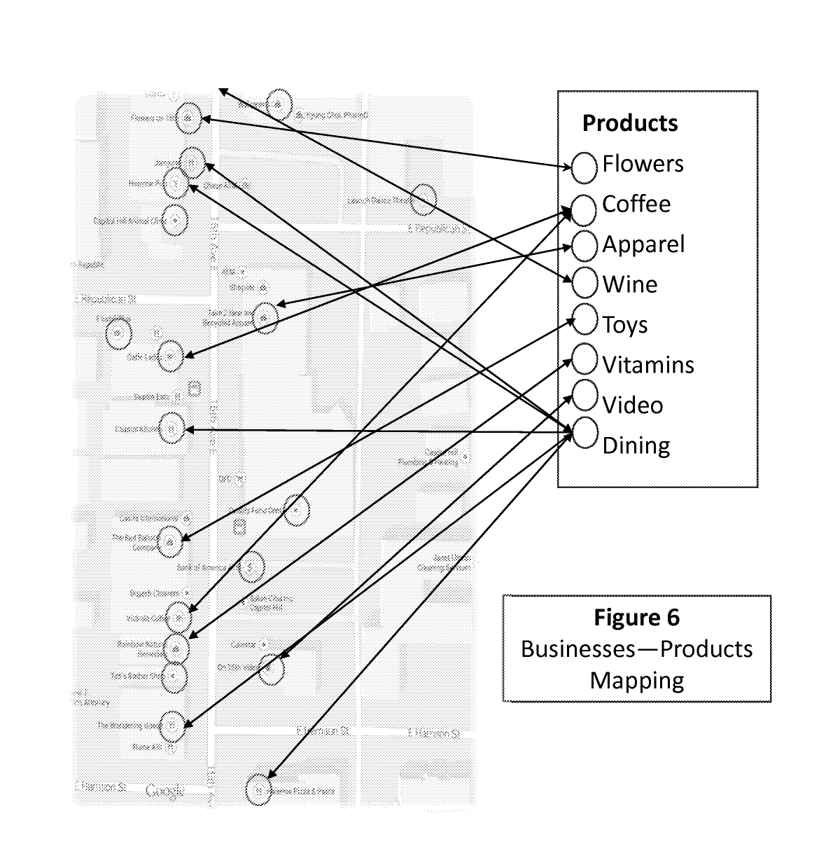

FIG. 6 illustrates an embodiment for business and products mapping. The mapping of FIG. 6 can be constructed independently of the social mapping, by simply generating a list of products and associating each product to businesses presented on the map. While not shown in this example, here again the thickness of the arrow may indicate strength of association. For example, a grocery store may carry flowers and has some association to product “flowers,” but a dedicated flower shop may be provided with a stronger association to product “flowers.”

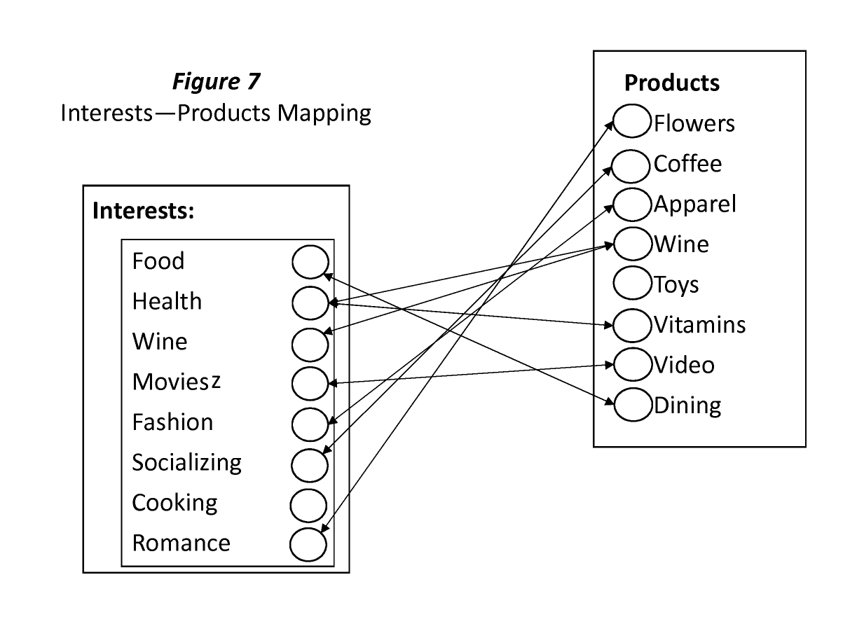

If a business and products mapping has been generated, it is also beneficial to associate products with interests. Such an example is illustrated in FIG. 7. This association closes the loop between users and products, thus enabling targeted marketing of products of potential interest for specific users. Consequently, an ad placed using this mapping has higher value since it is known from the user-interest mapping which users may be interested in which products.

Once the basic mapping has been generated, various mappings can be overlaid for different purposes. There are many combinations of the overlay of mappings, some examples provided below.

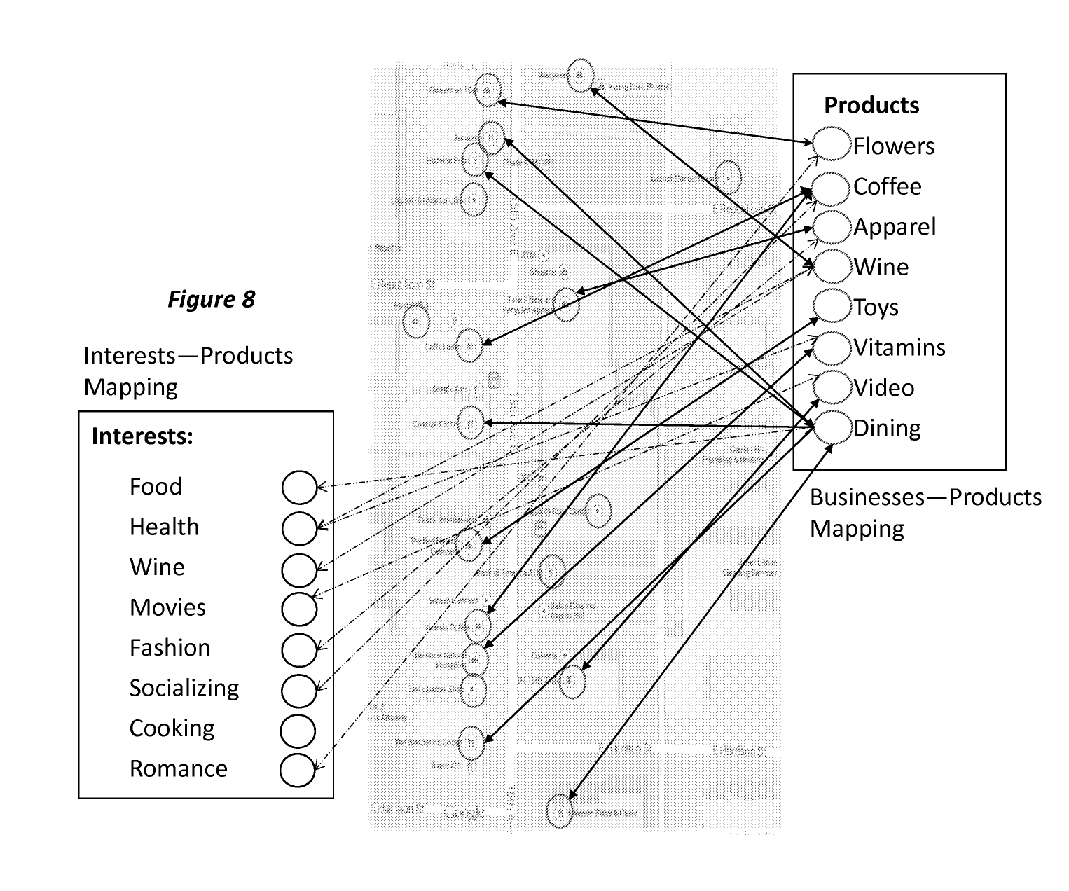

The association of products and interest can then be overlaid over the interest mapping. This is illustrated in FIG. 8. The diagram on FIG. 8 overlays the product-business associations with the product-interest associations, to indicate how one can associate interests with businesses. This could be used for advertising purposes, enabling businesses selling particular products to target their marketing to those users having the associated interest.

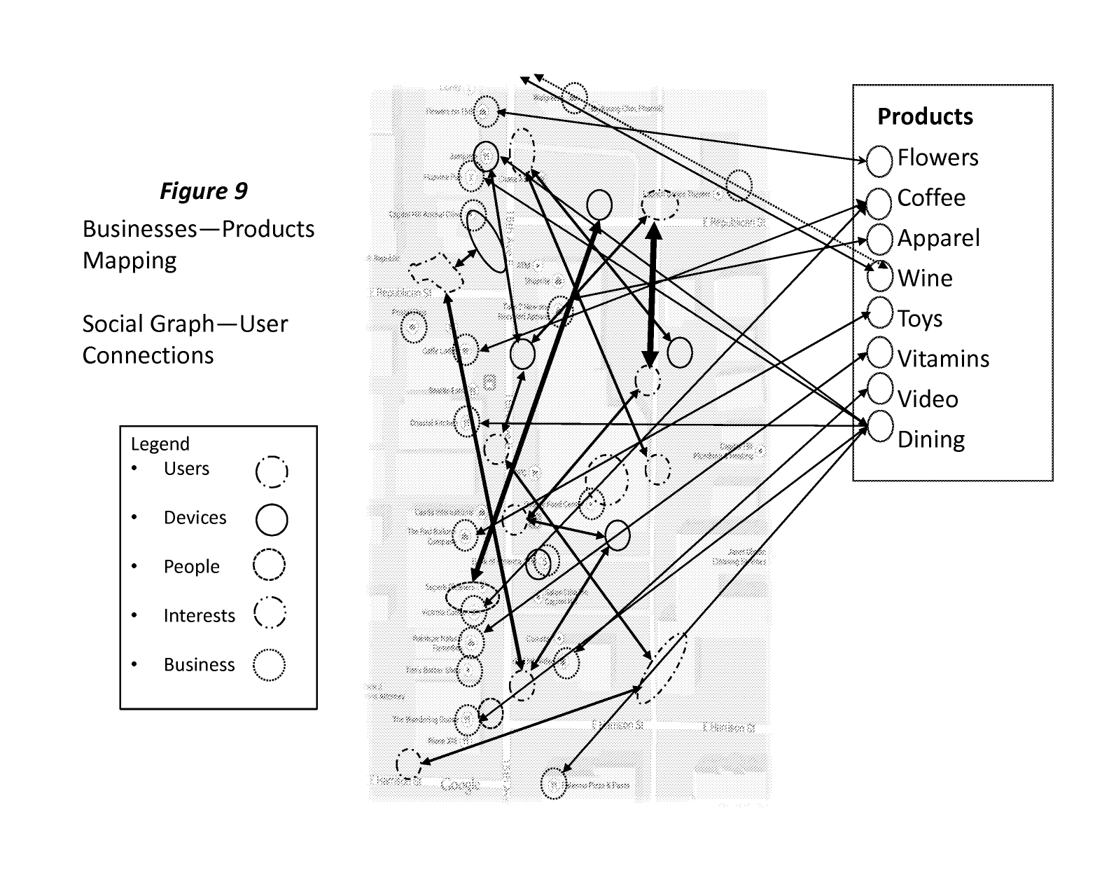

The diagram of FIG. 9 overlays the business-product mapping with the social diagram with just the user connections. This is a valuable mapping overlay which can be used for targeted marketing. For example, if it is known that a certain user has been visited a specific shoe store, and from the social network it is known that the person is an avid runner, it is safe to assume that the person is interested in running shoes. Moreover, from the social mapping it is known who that user's friends are with whom the user associates much, meaning those friends probably trust the user and appreciate his opinion. Thus, direct marketing to the user's friends can have higher value than random marketing.

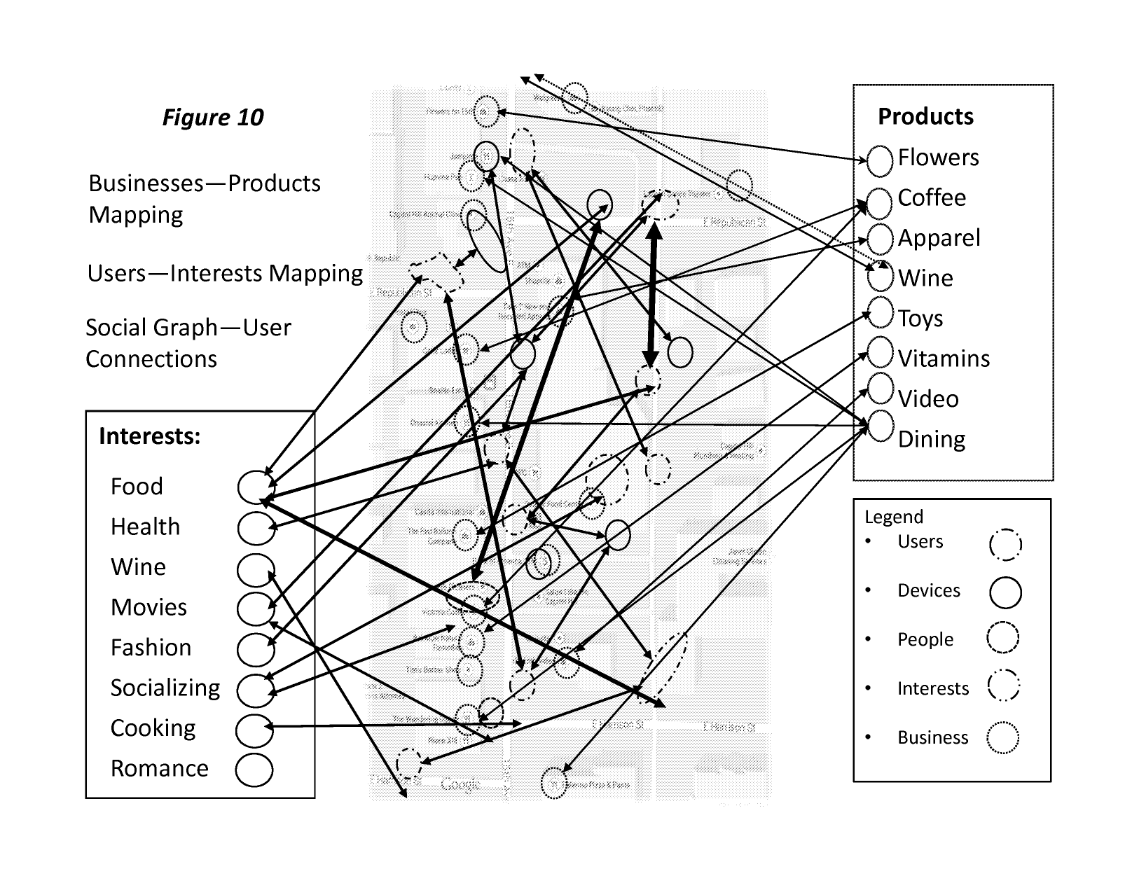

The diagram of FIG. 10 overlays the business-product map with the full social graph diagram, i.e. the social connections and the user interest information. This enables direct association between users, businesses and products.

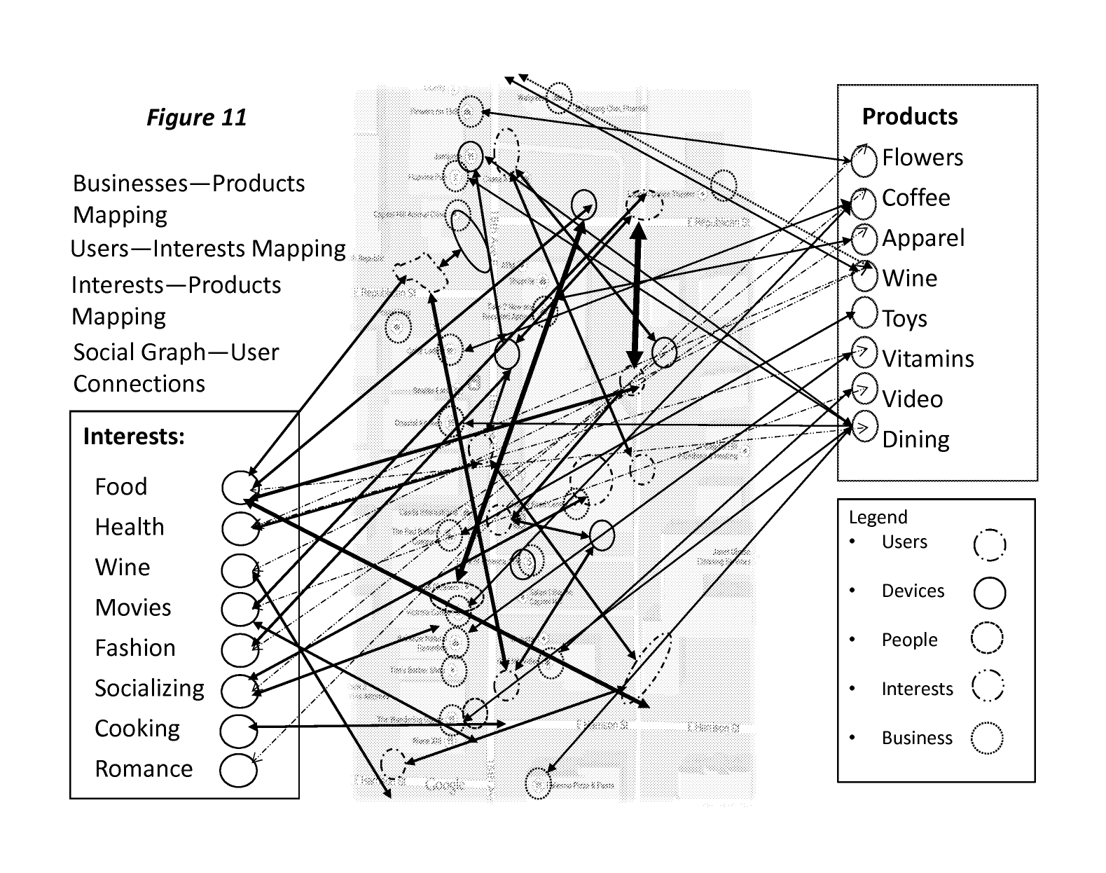

The diagram of FIG. 11 takes the mapping of FIG. 10 and adds the association of user interests with products. With this full graph, advertising possibilities become fully clear.

The system disclosed herein permits users to see who their friends and associates are (determined by the above co-location techniques), without ever specifying them explicitly. It also permits users to see different kinds of friendship categories, for example, coworkers, family members, golfing friends, and so on, appearing automatically in different lists, appropriately labeled. The user may see not only product recommendations, but also see the actual rationale for the recommendations, e.g. which friend or associate liked or purchased a given product, or has some other affinity with it. If a friend frequents a new location or buys a new product, a user may see related content. Users can also receive ads in apps that are different from the app that generated the location data. For example, a map app may not show you any ads, but our system can use location information generated by the map app to feed an ad network.

The disclosed system can be supported with a server-less implementation, as illustrated in FIG. 13. This is possible by installing clients on mobile devices and letting clients discover other nearby clients, and using this information to infer who they're close to. Each client then obtains a list of its friends without any server aggregating this information. This has privacy advantages and gives the client greater control. By not storing friendship data on any server, users can directly review and manipulate their friend lists and receive the benefits of them, without sharing this information with any central party.

In the example of FIG. 13, user A is first in one location and its client identifies users B and C. The client makes note of these neighboring devices, i.e., record the device/user ID, time, location, and optionally duration during which each device was still visible to device A. At this point client of device A does not have to assign any relationship to any of the other device. At a later time, user A moves to another location, as indicated by the broken-line arrow. At that location, User A's client detects users B and D, and makes a note of their presence. Since Device B was detected in both locations, the client may increase the weight given to the relationship between devices A and B. The weight may be increased using other parameters as well, such as time of day, duration, context, etc. For example, if device A senses device B every night, the weight would be increased, as they are probably related or are roommates. Similarly, if the first location was a restaurant and the second was a movie theatre, the weight may be increased since they probably dined together and went to movie together.

As an additional example, a user can use this information to gather more relevant recommendations. He may query a service for places where his friends have gone and rated highly, but the list of friends would not be given to anyone else. To enhance privacy further, a user could query a service about all nearby establishments, e.g., restaurants, together their ratings by various people, and then locally, weight the opinions and recommendations of his friends over those ratings given by people the user doesn't know (or ignore the opinions of non-friends altogether). In this scenario, information about a user's friends never leaves his device.

This has privacy and regulatory advantages. This gives the ability to serve high quality ads that otherwise would require intrusive practices, like centralized collection of information about user movements.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

1. A computer implemented method for generating a social network, comprising executing on one or more processors the steps of:
periodically collecting from a plurality of mobile devices of users tuples, wherein each tuple comprise data indicating location of the mobile device and time the tuple was generated;
cross correlating the tuples from the plurality of users to identify tuples that overlap in location and time;
generating an association between users having tuples that overlap in location and time; and,
storing in a memory a collection of associations to thereby generate the social network.

2. The method of claim 1, further comprising:
indicating a weight for each of the associations;
increasing the weight for an association in correlation with identification of repeated tuples that overlap in location and time.

3. The method of claim 1, wherein periodically collecting comprises:
installing apps in the users mobile devices, wherein each app fetches location and time data from its mobile device and wirelessly transmits a tuple of the location and time data.

4. The method of claim 3, further comprising:
whenever an association is generated, causing the app to prompt the user to accept or reject the new association.

5. The method of claim 1, wherein the tuple comprises: user ID, time, and location.

6. The method of claim 5, wherein the tuple further comprises location error.

7. The method of claim 6, wherein cross correlating overlap in location is determined within the location error.

8. The method of claim 7, further comprising generating a mapping wherein each location is marked by a curve of varying size, wherein the size correlates to the location error.

9. The method of claim 1, further comprising:
generating a list of interests;
associating each of the interests with at least one of a plurality of geographical locations;
cross correlating tuples from the plurality of users to identify tuples having location overlapping with one of the geographical locations; and,
generating an interest association between interests associated with the geographical locations and users having location overlapping with one of the geographical locations.

10. The method of claim 9, wherein each of the geographical locations comprises one of: a business establishment, a governmental building, an education facility, and a public park.

11. The method of claim 9, further comprising:
generating a list of products; and,
associating each of the products with at least one of the geographical locations.

12. The method of claim 9, further comprising:
generating a list of products; and,
associating each of the products with at least one of the interests.

13. The method of claim 12, further comprising generating an ad for one of the products and sending the ad to users included in the interest association of an interest associated with the product.

14. The method of claim 1, wherein periodically collecting comprises:
installing apps in the users mobile devices, wherein each app fetches location and time data from its mobile device and determines identifications of devices within its geographical location, and generates a tuple of the location, time, and identifications of devices within its geographical location data.

15. A computer implemented method for generating a mapping of a user interests, comprising executing on one or more processors the steps of:
periodically collecting from a user device a tuple indicating location and time;
cross correlating the tuples to a plurality of establishments;
generating an association between each establishment and a plurality of interests;
when a tuple overlaps in location with one of the plurality of establishments, generating an interest association between the user and the interest associated with the establishment; and,
storing a collection of interest associations.

16. The method of claim 15, further comprising generating a correlation of establishments and interests.

17. The method of claim 15, further comprising generating an inquiry to the user to accept or reject the interest association.

18. The method of claim 15, further comprising associating ads with interests, and sending users ads according to the interest associations.

19. The method of claim 15, further comprising:
indicating a weight for each of the association; and,
increasing the weight for an association in correlation with identification of repeated tuples that overlap in corresponding location and time.

20. The method of claim 15, further comprising generating a correlation of products and interests.

21. The method of claim 15, wherein the tuple comprises: device ID, time, location, and location error.

22. The method of claim 21, further comprising associating a username with the device ID.

23. The method of claim 21, further comprising associating the user's actual name with the device ID.

24. The method of claim 22, further comprising associating the user's actual name with the username.

25. A system for generating and maintaining a social network, comprising:
a server having a program with instructions causing the server to perform the operations comprising:
receiving plurality of tuples from plurality of mobile devices, each tuple comprising device ID, time, and geographic location;
cross correlating the tuples from the plurality of devices to identify tuples that overlap in location and time;
generating an association between devices having tuples that overlap in location and time; and,
storing a collection of associations;
an app configured for download and installation on mobile devices, the app having instruction to, when running on the mobile device, periodically perform the operations comprising:
obtain geographical location of the mobile device;
obtain local time;
assemble a tuple comprising a device ID, the geographical location, and the local time; and,
wirelessly transmit the tuple to the server.

26. The system of claim 25, further comprising:
transmitting from the server to each mobile device relevant associations from the collection of associations.

27. The system of claim 25, further comprising continuously updating the collection of associations according to tuples received from mobile devices.

28. The system of claim 25, further comprising:
for each device ID, when a new transmission of a tuple is received that overlaps in location and time with another device ID, checking whether the another device ID is already associated with the device ID and, when not, sending a message to the device sending the new transmission offering to add the another device ID to a social network.

29. The method of claim 25, further comprising:
indicating a weight for each of the associations;
increasing the weight for an association in correlation with identification of repeated tuples that overlap in location and time.

30. The method of claim 25, further comprising:
generating a list of interests;
associating each of the interests with at least one of a plurality of geographical locations;
cross correlating tuples from the plurality of users to identify tuples having location overlapping with one of the geographical locations; and,
generating an interest association between interests associated with the geographical locations and users having location overlapping with one of the geographical locations.

31. The method of claim 30, further comprising:
generating a list of products; and,
associating each of the products with at least one of the geographical locations.

32. The method of claim 25, further comprising maintaining at the server a correlation set correlating a list of products and a list of interests.

33. An application having instruction to, when running on a mobile device, periodically perform the operations comprising:
obtaining geographical location of the mobile device;
obtaining local time;
assembling a tuple comprising a device ID, the geographical location, and the local time;
wirelessly transmitting the tuple to a server; and,
receive from the server a list of devices having tuples that overlap in location and time.

34. The application of claim 33, further comprising receiving from the server an interest update corresponding to the tuples transmitted by the mobile device.

35. The application of claim 33, wherein device ID comprises username.

36. The application of claim 33, wherein obtaining geographical location comprises fetching the geographical location from a GPS application operating on the mobile device.

37. The application of claim 33, wherein obtaining local time comprises fetching the local time from a clock application operating on the mobile device.

38. The application of claim 33, further comprising receiving from the server and displaying on the mobile device an advertising for a product corresponding to the tuple transmitted by the mobile device.

39. A server having a program with instructions causing the server to perform the operations comprising:
receiving plurality of tuples from plurality of mobile devices, each tuple comprising device ID, time, and geographic location;
cross correlating the tuples from the plurality of devices to identify tuples that overlap in location and time;
generating an association between devices having tuples that overlap in location and time; and,
storing a collection of associations.

40. The server of claim 39, further comprising:
sending messages to devices having tuples that overlap in location and time indicating the association.

41. The server of claim 40, further comprising:
indicating a weight for each of the associations;
increasing the weight for an association in correlation with identification of repeated tuples that overlap in location and time.

42. A computer program with instructions causing a server to perform the operations comprising:
receiving plurality of tuples from plurality of mobile devices, each tuple comprising device ID, time, and geographic location;
for each of the mobile devices, cross correlating the tuples with a list of interests, wherein each interest is associated with at least one geographical location;
for each of the mobile devices generating and maintaining an interest association list; and,
storing and updating a collection of interest associations lists for the mobile devices.

43. The computer program of claim 42, further comprising instructions causing a server to perform the operations comprising sending to each mobile device the interest associations corresponding to the mobile device.

44. The computer program of claim 42, further comprising instructions causing a server to send to the mobile devices advertisements for a product corresponding to the list of interests for the mobile devices.

45. The computer program of claim 42, further comprising instructions causing a server to perform the operations comprising:
cross correlating the tuples from the plurality of users to identify tuples that overlap in location and time;
generating an association between users having tuples that overlap in location and time; and,
storing a collection of associations.

46. The computer program of claim 45, further comprising:
indicating a weight for each of the associations;
increasing the weight for an association in correlation with identification of repeated tuples that overlap in location and time.
